(19) United States
(12) Patent Application Publication
(10) Pub. No.: US 2019/0366473 A1
(43) Pub. Date: Dec. 5, 2019

(54) Metal additive manufacturing equipment utilizing semi-solid mental formation

(71) Applicants: XIAO DONG, Kirkland, WA (US); QING DONG, Kirkland, WA (US)

(72) Inventors: XIAO DONG, Kirkland, WA (US); QING DONG, Kirkland, WA (US)

(21) Appl. No.: 16/102,049

(22) Filed: Aug. 13, 2018

(30) Foreign Application Priority Data
May 29, 2018 (CN) 201810530778.1

(51) Int. Cl. B23K 20/12

(52) U.S. Cl. CPC B23K 20/1215; B33Y 30/00; B23K 20/1255; B23K 20/125

(57) ABSTRACT

The invention discloses a semi-solid additive manufacturing equipment and its manufacturing procedure. The equipment comprises a friction stir tool, a metal substrate and the additive metal material. The friction stir tool applies force to fixate the additive metal material to the metal substrate. The friction stir tool rotates, generate heat by making friction with the additive metal material and cuts into the additive metal material after it turns into semi-solid form. The friction stir tool moves along the direction of the additive metal material while continue applying force to fixate the metal material to the metal substrate. The said additive manufacturing equipment applies the concept of semi-solid formation, friction stir welding, and machinery theory to additive manufacturing and 3D printing. The results are improved process efficiency, enhanced product quality, increased material selections and cost reduction.

### BACKGROUND OF THE INVENTION

Additive manufacturing (e.g. metal 3D printing) integrates many technologies such as Computer-Aided Design (CAD), Computer-Aided Manufacturing (CAM), powder metallurgy and heat cladding. The basic principle is to generate 3D model with cross-sectional pattern and model the fused deposition and sintering path for the object to be formed. Heat source travels along the planned path and creates melt pool on the surface of the produced part, alloy powder is delivered to the melt pool and then cools off to form solid alloy. The heating source and the manufacturing station follows the predefined trajectory by CAD to produce the final product line by line and layer by layer. Different heating sources and processing technology can be used to produce final products with certain mechanical properties. 3D metal printing technology can be applied to many areas, such as mold manufacturing and repair, turbine blades repair, rapid prototyping, etc. Typically, 3D metal printing technology is thought to be complementary to the traditional manufacturing methods. It is good for materials that have high unit cost and products that are hard to manufacture with traditional methods (e.g. products with complex or irregular shape). However, current 3D metal printing also has some limitations:
1) Current 3D printing technology often use powder material as the feeding materials, however, such procedure means the materials have low efficiency of cladding, it need extra time to process material into powder and are susceptible to various of defect (e.g. porosity, hot-cracking).
2) Alloy powders are limited in type and are expensive, constraining the additive manufacturing methods that utilize metal powder as the feeding material.
3) The expensive laser, electron or plasma heating component makes the 3D printing technology utilizing those components hard to be adopted universally.

### SUMMARY OF THE INVENTION

The present invention presents a 3D printing equipment and procedure that adopt the concept of friction stir welding to perform semi-solid metal additive manufacturing. The invention increases the available types of additive materials, increases energy efficiency and reduces the processing cost compared with the traditional metal melting 3D printing technology.

The equipment of this invention includes, a friction stir tool, a metal substrate and metal material for additive manufacturing. The friction stir tool applies force to fixate the additive metal material to the metal substrate or previously finished welds. The friction stir tool rotates, generate heat by making friction with the additive metal material and cuts into the additive metal material after it turns into semi-solid form. The friction stir tool moves along the direction of the additive metal material while continue applying force to fixate the metal material to the metal substrate or previously finished welds.

The metal additive material mentioned in the present invention can take the shape of strip, rod, plate or thread. The friction stir tool can have thread on the surface and a friction stir shoulder. The friction stir tool rotates and make friction with the additive metal material, the heat that is generated from the friction can heat the additive material to reach the semi-solid state. The friction stir tool cuts into the semi-solid metal additive material and moves pass the touching surface between the metal additive material and the metal substrate and into the metal substrate for a small amount. The heat generated in the process also turn part of the metal substrate into semi-solid form. When the friction stir tool cutes into the metal substrate for the small amount, the fast rotation from the tool can mix the metal additive material with the metal substrate and form solid bonding. As the friction stir tool moves from one end of the additive material to the other end, the metal additive material and the meal substrate are joint together. This completes the additive manufacturing of one raised weld. The height of the raised weld is the smallest increment height of the additive manufacturing process. Subsequent additive metal material can be added to the metal substrate side by side with the existing raised weld, alternatively, the subsequent additive metal material can be added directly on to the existing raised weld. Of course, the movement of friction stir tool and the sequence of additive metal material can be designed in advance to form different raised welds which can then be combined to form finished product.

The FSW mechanism in this invention produces convex weld with programmable path, which makes it possible to use friction stir welding as a way for 3D printing and additive manufacturing. The invention improves the additive manufacturing efficiency, increases the available source materials for 3D printing and reduces the cost. The use of friction stir tool speeds up the product forming speed and improves the production efficiency, there are also a large selection of additive metal material and the metal substrate which increases the availability of this additive process. Compared with the prior art, the advantages of the current invention are: the semi-solid processing and the friction stir welding concepts are applied to the additive manufacturing 3D printing technology, thereby achieving the purpose of improving the processing efficiency, increasing the additive quality, increasing the material source, and reducing the processing cost.

The additive manufacturing procedure in this invention includes:
1. Put metal substrate (e.g. 2000 series aluminum alloy) on the work surface
2. Lay additive metal material (e.g. 2000 series aluminum alloy) on top of the metal substrate. Usually the additive metal material is thin (e.g. 12 mm) and has the same length as the metal substrate.
3. Put friction stir tool at one end of the additive metal material. Let the friction tool rotates and cuts into the additive metal material.
4. The friction stir tool rotates (e.g. 300-600 rpm) and moves (e.g. with a speed of 30-47.5 mm/m) along the length direction of the additive metal material from one end to the other end. The contacting region of the additive metal material with the friction stir tool is heated up to semi-solid form (e.g. 300 C-460 C for 2000 series aluminum alloy) due to heat generated by friction. As the friction stir tool moves the additive metal material and the metal substrate mixed together to form a recrystallization zone (e.g. a good thickness of such zone is around 0.09 mm-0.3 mm deep).
5. The friction stir tool moves to the other end of the metal additive material and the metal substrate, and eventually comes out of contact with the metal substrate and the additive material.
6. Put another metal additive material (e.g. the same 2000 series aluminum alloy) in position for another weld. The position the metal additive material can be either in contact with the metal substrate and side by side with the first weld, or on top of the first weld without touching the metal substrate. The thickness and the length of the metal additive material is the same as the first weld.
7. Put friction stir tool at one end of the additive metal material. Let the friction tool rotates and cuts into the additive metal material.
8. The friction stir tool rotates (e.g. 300-600 rpm) and moves (e.g. with a speed of 30-47.5 mm/m) along the length direction of the additive metal material from one end to the other end. The contacting region of the additive metal material with the friction stir tool is heated up to semi-solid form (e.g. 300 C-460 C for 2000 series aluminum alloy) due to heat generated by friction. As the friction stir tool moves the additive metal material and the metal substrate mixed together to form a recrystallization zone (e.g. a good thickness of such zone is around 0.09 mm-0.3 mm deep).
9. The friction stir tool moves to the other end of the metal additive material and the metal substrate, and eventually comes out of contact with the metal substrate and the additive material.
10. Repeat steps 6-9 for the metal additive manufacturing procedure.

The above steps summarize the procedure for metal additive manufacturing. The movement of the friction stir tool can be planed and designed ahead of time just like a 3D printer. The additive metal materials and the metal substrate have large selections. For example, 2000 series aluminum alloy, 6000 series aluminum alloy, 7000 series aluminum alloy, magnesium alloy, A306 steel, and titanium alloy which can all be plasticized by the friction tool.

### DESCRIPTION OF THE DRAWINGS

FIG. 1 is a schematic diagram of a first embodiment of the present semi-solid additive manufacturing equipment invention.

FIG. 2 is a schematic diagram of a second embodiment of the present semi-solid additive manufacturing equipment invention.

FIG. 3 is a schematic diagram of the additive manufacturing procedure results using the first embodiment in FIG. 1.

FIG. 4 is a schematic diagram of the additive manufacturing procedure results using the second embodiment in FIG. 2.

### DETAILED EMBODIMENT OF THE INVENTION

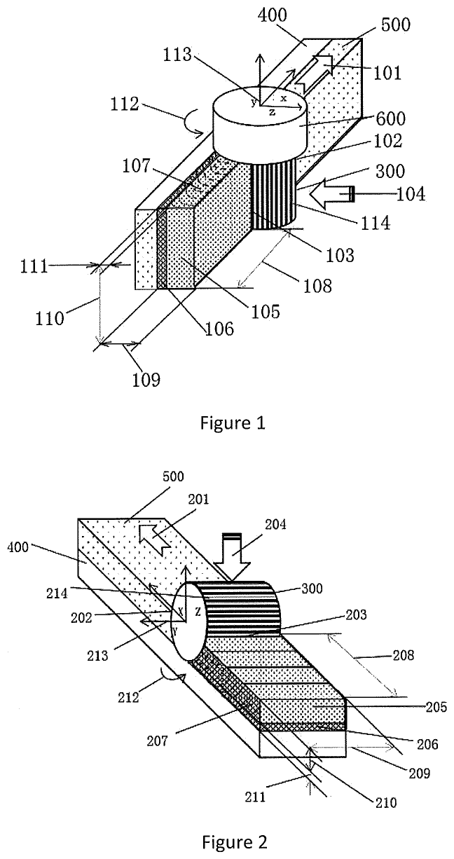

Please refer to FIG. 1 to FIG. 4, the present invention of semi-solid additive manufacturing equipment includes a friction stir 300, a metal substrate 400, and a metal additive material 500. The metal additive material 500 is laid in contact with the substrate 400 and has the same length with the substrate along the x-axis. The friction stir tool 300 applies force (−z direction) on the additive metal material to fix it to the metal substrate 400. The metal substrate 400 is fixed onto the work surface.

More specifically, friction stir tool 300 rotates and makes friction with the metal additive material 500, the heat that is generated from the friction can heat metal additive material 500 to reach the semi-solid state so that friction stir tool 300 can cut into the body of the metal additive material 500. As the friction stir tool 300 moves into the body of the metal additive material 500 more and reaches the contact surface between the additive material 500 and the metal substrate 400. The material close to the contact surface of the metal substrate 400 and the additive material 500 also reaches semi-solid state due to the heat generated by friction. The high-speed rotation motion of the friction stir tool 300 mixes the semi-solid metal from the metal substrate 400 and the additive metal material 500 together. The welding overlap 111 measures the distance that the friction stir tool 300 moves into the metal substrate 400 along the −z direction. As the friction stir tool 300 travel along the x axis, from one end of the additive material 500 to the other end, it pushes and bonds the additive material 500 and the substrate 400 together. The raised weld forms on top of the welding overlap 111. The height of the raised weld 109 is the minimum height of this additive manufacturing process. Once the friction stir tool 300 moves from one end of the additive material 500 to the other end, it completes adding one raised weld. The second additive material 500 can be added side by side (y axis) to the existing raised weld, the friction stir tool 300 weld the new additive material 500 onto the metal substrate 400 to form another raised weld connected to the existing raised weld. Alternatively, the second additive material 500 can be added on top of (z axis) the existing raised weld, the friction stir tool 300 weld the additive material 500 onto the existing raised weld which is treated as the metal substrate in welding of the second weld. Repeating these processes can form different shapes of the finished metal parts. The trajectory of the friction tool 300 can be designed in advance to form different raised welds, eventually combining a variety of raised welds to form the desired shape of the metal products. The use of friction stir welding concept speeds up the additive manufacturing process and improves the production efficiency. There are also a large selection of the additive material 500 and the metal substrate 400 which increases the availability of this additive manufacturing process and reduces cost. Compared with the prior art, the advantages of the current invention are: the semi-solid processing and the friction stir welding concepts are applied to the additive manufacturing 3D printing technology, thereby achieving the purpose of improving the processing efficiency, increasing the additive quality, increasing the material source, and reducing the processing cost. It not only has the advantages of traditional friction stir welding, but also eliminates the need for heavy fixtures to limit the clamping of each layer of weld. The friction stir tool 300 can be control by CNC to plan, design and control the movement of 300 in relation to the metal substrate 400. The materials for additive material 500 and metal substrate 400 have large selection. For example, 2000 series aluminum alloy, 6000 series aluminum alloy, 7000 series aluminum alloy, magnesium alloy, A306 steel, and titanium alloy which can all be plasticized by the friction tool 300.

The shape of the additive material 500 in the present invention can be a bar or a rod or a plate. These shapes of 500 can ensure the friction stir tool 300 make friction stir welding on top of it. The solid metal becomes soft due to heat generated from pressure and friction. Essentially the metal additive material 500 is turned into the semi-solid form. The same thing happens to the metal substrate. The metallurgical bond is formed between the metal substrate 400 and additive material 500 once the friction stir tool 300 mixes them together.

Two embodiments of the invention are discussed below.

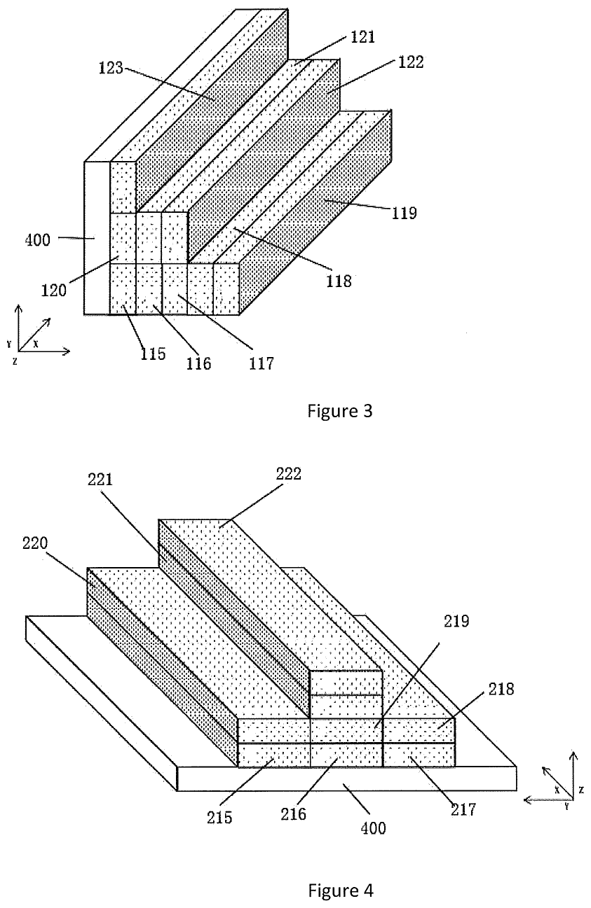

The first embodiment is when the metal substrate is positioned vertically in the physical space. As shown in FIG. 1, the friction stir tool 300 rotates following the rotation 112 while pressing the friction metal substrate 400 and metal additive material 500 along the direction of the sideward force 104. The friction stir tool 300 rotates, creates friction and makes the additive material 500 plasticized while applying pressure. The friction stir tool 300 cuts into the additive material 500. The rotation of friction stir tool moves the metal from the advancing side 102 to the retreating side 103. Due to the heat generated by friction, the metal additive material 500 is plasticized and reach the semi-solid form. As the friction stir tool moves into the metal additive material 500 more and more along the z axis. The contacting portion of metal substrate 400 is also plasticized by the heat and reach the semi-solid form. The spinning motion of the friction stir tool 300 and the thread 114 on the surface of the tool help mix the semi-solid metal 500 and 400 together and form solid bonding. After the friction stir tool 300 moves from one end of the metal additive material 500 to the other end, the metal additive material are welded to the metal substrate 400. The raised weld forms on top of the welding overlap 111. The height of the raised weld 109 is the minimum height of additive manufacturing. Once the friction stir tool 300 moves from one end of the metal additive material 500 to the other end, it completes adding one raised weld. Another metal additive material 500 can be added along the y axis side by side to the existing raised weld, the friction stir tool 300 weld the new additive material 500 onto the metal substrate 400 to form another raised weld connected to the existing raised weld. Alternatively, the second additive material 500 can be added on top of (z axis) the existing raised weld, the friction stir tool 300 weld the additive material 500 onto the existing weld which is treated as the meatal substrate in welding of the second weld. Multiple raised welds can form raised steps, multiple steps can form the shape of the final 3d metal parts. Using raised welds for additive manufacturing require carefully designed manufacturing process according to the contour of the final products. One example can be found in FIG. 3. Nine raised welds can form three raised steps. The process is following:
1. The first raised weld 115 is produced by having friction stir tool 300 weld additive material 500 on metal substrate 400.
2. The second raised weld 116 is produced by having friction stir tool 300 weld another additive material 500 directly on top of (z axis) the first raised weld 115.
3. The third raised weld 117 is produced by having friction stir tool 300 weld another additive material 500 on top of (z axis) the second raised weld 116.
4. The fourth raised weld 118 is produced by having friction stir tool 300 weld another additive material 500 on top of (z axis) the third raised weld 117.
5. The fifth raised weld 119 is produced by having friction stir tool 300 weld another additive material 500 on top of (z axis) the fourth raised weld 118.
6. The sixth raised weld 120 is produced by having friction stir tool 300 weld another additive material 500 on the metal substrate 400 side by side (y axis) with the first raised weld 115.
7. The seventh raised weld 121 is produced by having friction stir tool 300 weld another additive material 500 on top of (z axis) the sixth raised weld 120.
8. The eighth raised weld 122 is produced by having friction stir tool 300 weld another additive material 500 on top of (z axis) the seventh raised weld 121.
9. The ninth raised weld 123 is produced by having friction stir tool 300 weld another additive material 500 on the metal substrate 400 side by side (y axis) with the sixth raised weld 120.

Changing the size and shape of the metal substrate 400 and additive material 500 can change the size and shape of the raised welds, which in return controls the accuracy level of the additive manufacturing process. The shape of the friction stir tool 300 can vary depends on the needs. For example, it can be a cylinder, or a sphere. The friction stir tool 300 could also have tool thread 114 on the surface to improve the welding performance as it can mix the metal additive material 500 and the metal substrate 400 better.

The second embodiment is when the metal substrate is laid horizontally in the physical space. As shown in FIG. 2, the friction stir tool 300 rotates following the rotation 212 while pressing the friction metal substrate 400 and metal additive material 500 along the direction of the downward force 204. The friction stir tool 300 rotates, creates friction and makes the additive material 500 plasticized while applying pressure. The friction stir tool 300 cuts into the additive material 500. The rotation of friction stir tool moves the metal from the advancing side 202 to the retreating side 203. Due to the heat generated by friction, the metal additive material 500 is plasticized and reach the semi-solid form. As the friction stir tool moves into the metal additive material 500 more and more along the z axis. The contacting portion of metal substrate 400 is also plasticized by the heat and reach the semi-solid form. The spinning motion of the friction stir tool 300 and the thread 214 on the surface of the tool help mix the semi-solid metal 500 and 400 together and form solid bonding. After the friction stir tool 300 moves from one end of the metal additive material 500 to the other end, the metal additive material are welded to the metal substrate 400. The raised weld forms on top of the welding overlap 211. The height of the raised weld 210 is the minimum height of additive manufacturing. Once the friction stir tool 300 moves from one end of the metal additive material 500 to the other end, it completes adding one raised weld. Another metal additive material 500 can be added along the y axis side by side to the existing raised weld, the friction stir tool 300 weld the new additive material 500 onto the metal substrate 400 to form another raised weld connected to the existing raised weld. Alternatively, the second additive material 500 can be added on top of (z axis) the existing raised weld, the friction stir tool 300 weld the additive material 500 onto the existing weld which is treated as the meatal substrate in welding of the second weld. Multiple raised welds can form raised steps, multiple steps can form the shape of the final 3d metal parts. Using raised welds for additive manufacturing require carefully designed manufacturing process according to the contour of the final products. One example can be found in FIG. 4. Eight raised welds can form three raised steps. The process is following:
1. The tenth raised weld 215 is produced by having friction stir tool 300 weld additive material 500 on metal substrate 400.
2. The eleventh raised weld 216 is produced by having friction stir tool 300 weld another additive material 500 on the metal substrate 400 side by side (y axis) with the tenth raised weld 215.
3. The twelfth raised weld 217 is produced by having friction stir tool 300 weld another additive material 500 on the metal substrate 400 side by side (y axis) with the eleventh raised weld 216.
4. The thirteenth raised weld 218 is produced by having friction stir tool 300 weld another additive material 500 on top of (z axis) the twelfth raised weld 217.
5. The fourteenth raised weld 219 is produced by having friction stir tool 300 weld another additive material 500 on top of (z axis) the eleventh raise weld 216 side by side (y axis) with the thirteenth raised weld 218.
6. The fifteenth raised weld 220 is produced by having friction stir tool 300 weld another additive material 500 on top of (z axis) the tenth raise weld 215 side by side (y axis) with the fourteenth raised weld 219.
7. The sixteenth raised weld 221 is produced by having friction stir tool 300 weld another additive material 500 on top of (z axis) the fourteenth raised weld 219.
8. The seventeenth raised weld 222 is produced by having friction stir tool 300 weld another additive material 500 on top of (z axis) the sixteenth raised weld 220.

The friction stir tool 300 in the current invention can also have tool shoulder 600. The should 600 helps with the fixation of the friction tool 300 with the metal additive material 500 along the x and y axis to avoid the additive material 500 slides out of contact with the friction stir tool 300 during the additive manufacturing process.

The additive manufacturing procedure presented in this invention can be:
1. Put metal substrate 400 (e.g. 2000 series aluminum alloy) on the work surface
2. Lay additive metal material 500 (e.g. 2000 series aluminum alloy) on top of the metal substrate 400. Usually the additive metal material 500 is thin (e.g. 12 mm) and has the same length as the metal substrate 400.
3. Put friction stir tool 300 at one end of the additive metal material 500. Let the friction tool 300 rotates and cuts into the additive metal material 500.
4. The friction stir tool 300 rotates (e.g. 300-600 rpm) and moves (e.g. with a speed of 30-47.5 mm/m) along the length direction of the additive metal material 500 from one end to the other end. The contacting region of the additive metal material 500 with the friction stir tool 300 is heated up to semi-solid form (e.g. 300 C-460 C for 2000 series aluminum alloy) due to heat generated by friction. As the friction stir tool 300 moves, the additive metal material 500 and the metal substrate 400 mixed together to form a recrystallization zone (e.g. a good thickness of such zone is around 0.09 mm-0.3 mm deep).
5. The friction stir tool 300 moves to the other end of the metal additive material 500 and the metal substrate 400, and eventually comes out of contact with the metal substrate 400 and the additive material 500.
6. Put another metal additive material 500 (e.g. the same 2000 series aluminum alloy) in position for another weld. The position the metal additive material 500 can be either in contact with the metal substrate 400 and side by side (y axis) with the first weld, or on top of (z axis) the first weld without touching the metal substrate 400. The thickness and the length of the metal additive material 500 is the same as the first weld.
7. Put friction stir tool 300 at one end of the additive metal material 500. Let the friction tool 300 rotates and cuts into the additive metal material 500.
8. The friction stir tool 300 rotates (e.g. 300-600 rpm) and moves (e.g. with a speed of 30-47.5 mm/m) along the length direction of the additive metal material 500 from one end to the other end. The contacting region of the additive metal material 500 with the friction stir tool 300 is heated up to semi-solid form (e.g. 300 C-460 C for 2000 series aluminum alloy) due to heat generated by friction. As the friction stir tool 300 moves the additive metal material 500 and the metal substrate 400 mixed together to form a recrystallization zone (e.g. a good thickness of such zone is around 0.09 mm-0.3 mm deep).
9. The friction stir tool 300 moves to the other end of the metal additive material 500 and the metal substrate 400, and eventually comes out of contact with the metal substrate 400 and the additive material 500.
10. Repeat steps 6-9 for the metal additive manufacturing procedure.
it is of course possible to design the trajectory of the friction tool 300 in advance to form different raised welds, eventually constructing metal parts with a variety of shapes. This process has potentially faster manufacturing speed, better energy efficiency, and with a large selection of 500 and 400. For example, metals such as 2 series aluminum alloys, 6 series aluminum alloys, 7 series aluminum alloys, magnesium alloys, A3 steels, and titanium alloys may be plasticized by the friction tool head 300.

The above steps summarize the procedure for metal additive manufacturing. The movement of the friction stir tool 300 can be planed and designed ahead of time just like a 3D printer. It is of course possible to design the trajectory of the friction tool 300 in advance to form different raised welds, eventually constructing metal parts with a variety of shapes. This process has potentially faster manufacturing speed, better energy efficiency, and with a large selection of 500 and 400. For example, 2000 series aluminum alloy, 6000 series aluminum alloy, 7000 series aluminum alloy, magnesium alloy, A306 steel, and titanium alloy which can all be plasticized by the friction tool 300.

The above only describes several specific embodiments of the present invention, but it cannot be regarded as the only scope of the present invention. Any equivalent change—modification or proportional enlargement or reduction made according to the design in the present invention, should be considered in the projection scope of the present invention.

Reference numbers in the graph:

| | |
|---|---|
| 101 - friction stir tool welding | 102 - advancing side |
| direction | |
| 103 - retreating side | 104 - sideward force |
| 105 - recrystallization zone | 106 - recrystallization bonding zone |
| 107 - material adding area | 108 - length of the added material |
| 109 - height of the raised weld | 110 - width of the added material |
| 111 - welding overlap | 112 - direction of rotation |
| 113 - coordinate system for the | 114 - friction stir thread |
| first embodiment | |
| 115 - first raised weld | 116 - second raised weld |
| 117 - third raised weld | 118 - fourth raised weld |
| 119 - fifth raised weld | 120 - sixth raised weld |
| 121 - seventh raised weld | 122 - eighth raised weld |
| 123 - ninth raised weld | |
| 201 - friction stir tool welding | 202 - advancing side |
| direction | |
| 203 - retreating side | 204 - downward force |
| 205 - recrystallization zone | 206 - recrystallization bonding zone |
| 207 - material adding area | 208 - length of the added material |
| 209 - width of the added material | 210 - height of the added material |
| 211 - welding overlap | 212 - direction of rotation |
| 213 - coordinate system for the | 214 - Friction stir thread |
| second embodiment | |
| 215 - tenth raised weld | 216 - eleventh raised weld |
| 217 - twelfth raised weld | 218 - thirteenth raised weld |
| 219 - fourteenth raised weld | 220 - fifteenth raised weld |
| 221 - sixteenth raised weld | 222 - seventeenth raised weld |
| 300 - friction stir tool | 400 - metal substrate |
| 500 - metal additive material | 600 - friction stir tool shoulder |

We claim:

1. A semi-solid metal additive manufacturing equipment comprising: a friction stir tool, a metal substrate and metal additive material, with the friction stir tool rotates and applies forces perpendicular to its rotation axis onto the metal additive material and metal substrate.

2. The semi-solid metal additive manufacturing equipment per claim 1, whereas the friction stir tool is a cylindrical tool which rotates, makes friction, heats the metal substrate and the metal additive material up to reach semi-solid form for additive manufacturing.

3. The semi-solid metal additive manufacturing equipment per claim 2, whereas the metal additive material takes the form of strip, rod, plate or thread.

4. The semi-solid metal additive manufacturing equipment per claim 2, whereas the metal substrate is positioned vertically, and the friction stir tool applies force to join the additive metal material with the metal substrate.

5. The semi-solid metal additive manufacturing equipment per claim 4, whereas the friction stir tool has thread on the surface.

6. The semi-solid metal additive manufacturing equipment per claim 2, whereas the metal substrate is positioned horizontally, and the friction stir tool applies force to join the additive metal material with the metal substrate.

7. The semi-solid metal additive manufacturing equipment per claim 6, whereas the friction stir tool has thread on the surface.

8. The semi-solid metal additive manufacturing equipment per claim 4, whereas the friction stir tool has shoulder.

9. The semi-solid metal additive manufacturing equipment per claim 6, whereas the friction stir tool has shoulder.

10. A semi-solid metal additive manufacturing procedure containing the following steps:
Put metal substrate (e.g. 2000 series aluminum alloy) on the work surface
Lay additive metal material (e.g. 2000 series aluminum alloy) on top of the metal substrate. Usually the additive metal material is thin (e.g. 12 mm) and has the same length as the metal substrate;
Put friction stir tool at one end of the additive metal material. Let the friction tool rotates and cuts into the additive metal material;
The friction stir tool rotates (e.g. 300-600 rpm) and moves (e.g. with a speed of 30-47.5 mm/m) along the length direction of the additive metal material from one end to the other end. The contacting region of the additive metal material with the friction stir tool is heated up to semi-solid form (e.g. 300 C-460 C for 2000 series aluminum alloy) due to heat generated by friction. As the friction stir tool moves the additive metal material and the metal substrate mixed together to form a recrystallization zone (e.g. a good thickness of such zone is around 0.09 mm-0.3 mm deep);
The friction stir tool moves to the other end of the metal additive material and the metal substrate, and eventually comes out of contact with the metal substrate and the additive material;
Put another metal additive material (e.g. the same 2000 series aluminum alloy) in position for the second weld. The position of the second metal additive material can be either in contact with the metal substrate and side by side with the first weld, or on top of the first weld without touch the metal substrate. The thickness and the length is the same as the first weld;
Put friction stir tool at one end of the additive metal material. Let the friction stir tool rotates and cuts into the additive metal material;
The friction stir tool rotates (e.g. 300-600 rpm) and moves (e.g. with a speed of 30-47.5 mm/m) along the length direction of the additive metal material from one end to the other end. The contacting region of the additive metal material with the friction stir tool is heated up to semi-solid form (e.g. 300 C-460 C for 2000 series aluminum alloy) due to heat generated by friction. As the friction stir tool moves the additive metal material and the metal substrate mixed together to form a recrystallization zone (e.g. a good thickness of such zone is around 0.09 mm-0.3 mm deep);
The friction stir tool moves to the other end of the metal additive material and the metal substrate, and eventually comes out of contact with the metal substrate and the additive material;
Repeat steps 6-9 for the metal additive manufacturing procedure.
